(19) United States
(12) Patent Application Publication
(10) Pub. No.: US 2011/0050582 A1
(43) Pub. Date: Mar. 3, 2011

(54) INPUT DEVICE FOR ELECTRONIC APPARATUS

(75) Inventors: Huaqiao MA, Shanghai (CN); Tienyu Wang, Shanghai (CN); Wen-I Cheng, Shanghai (CN)

(73) Assignees: INVENTEC APPLIANCES CO., LTD; INVENTEC APPLIANCES CORP.

(21) Appl. No.: 12/794,413

(22) Filed: Jun. 4, 2010

(30) Foreign Application Priority Data
Aug. 28, 2009 (CN) 200910194776.0

(51) Int. Cl. G06F 3/045; G06F 3/02; G06F 3/048

(52) U.S. Cl. 345/169; 345/174; 715/773

(57) ABSTRACT

An electronic device (100) includes a display (106) configured to display a content, an input device (104) and a microprocessor (108) operatively coupled to the display (106) and the input device (104). The input device (104) includes a touch screen (112) and a key array (114) positioned on the touch screen (112). The touch screen (112) at least partially covers the display (106), and the key array (114) includes a plurality of keys. The input device (104) is configured to generate an input signal when at least one of the keys in the key array (114) is pressed to touch the touch screen (112). The microprocessor (108) is configured to control the content displayed on the display (106) in response to the input signal received from the input device (104).

### FIELD OF INVENTION

The present invention relates to electronic device input Specifically, the present invention relates to input having a touch screen input for an electronic device.

### BACKGROUND OF INVENTION

Various types of electronic devices are frequently used in daily life. As an interface for users, input devices of an electronic device especially receive more and more attentions from the users. Character/letter input devices, such as, for example, keyboards are wildly used in portable or handheld electronic devices, such as, for example, mobile phones, personal digital assistants and electronic dictionaries. Generally, such character/letter input devices can be classified into two categories: wholly mechanical devices and touch screens.

A known wholly mechanical keyboards includes a plurality of keys, a metal dome plate positioned below the keys and a flexible printed circuit board (PCB) under the dome plate. Generally, a reinforcement plate is provided below the flexible printed circuit board. The dome palate may be pressed to elastically deform, so as to selectively switched on or off the circuit on the flexible PCB. In addition, a light guide plate and at least one Light Emitting Diode (“LED”) may be positioned blow the plurality of keys to provide light source for the keyboard. Alternatively, an Electronic Luminescence (“EL”) board may be used as the illumination. Such a mechanical keyboard generally has a complicated structure and a thick dimension, and requires a big amount of components. In addition, such a mechanical keyboard occupies a large amount of General Purpose Input Output (GPIO) ports of a microprocessor in the electronic device for transmitting input signals from the keyboard.

Touch screens are also widely used in electronic devices. The electronic devices may display a virtual keyboard, and a touch screen may detect the touch and/or contact of a touch pen or a finger on the touch screen and generates an input signal. Although the touch screen has a relative few components, they generally lack tactile feedbacks. Therefore, the input speed through the touch screens is slow. In addition, with the trend of miniaturization of portable or handheld electronic devices, the input area of each character and/or letter displayed on the touch screen are getting smaller and smaller, which increases the possibility of misoperation and brings inconvenience to the users.

### BRIEF DESCRIPTION OF THE DRAWINGS

The inventions claimed and/or described herein are further described in terms of exemplary embodiments with reference to the drawings. The drawings are not necessarily drawn to scales. These embodiments are non-limiting exemplary embodiments, in which like reference numerals represent similar structures throughout the drawings, and wherein:

FIG. 1 is a top view of a mobile device according to an exemplary embodiment of the prevent invention;

FIG. 2 is a partial top view of an input device of the mobile device shown in FIG. 1;

FIG. 3 is a partial side view of the input device shown in FIG. 2;

FIG. 4 is an enlarged cross-sectional view of an exemplary key in the input device shown in FIG. 2;

FIG. 5 is a cross-sectional view of the mobile device shown in FIG. 1;

FIG. 6 is a block diagram of an exemplary system applicable to the mobile device shown in FIG. 1.

### DETAILED DESCRIPTION OF VARIOUS EMBODIMENTS

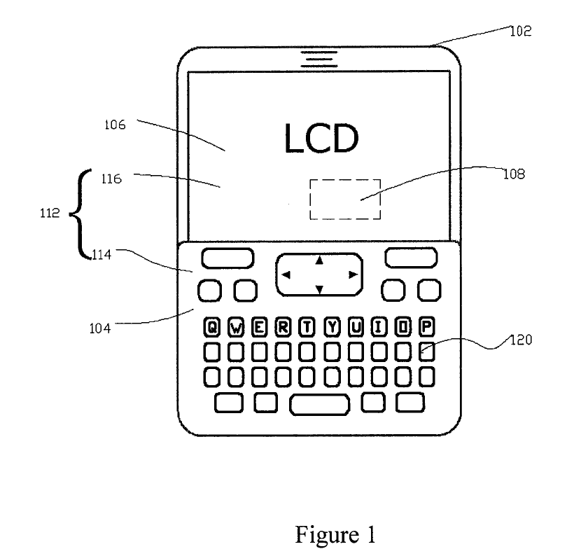

FIG. 1 is a top view of an exemplary mobile phone 100 applicable to the present invention. The mobile phone 100 includes a phone body 102, an input device 104, a display 106 and a microprocessor 108. Input device 104 may also be referred as an input unit or an input element. In the illustrated embodiment, the display 106 is positioned on the upper portion of the phone body 102. In the exemplary embodiment, the microprocessor 108 is positioned inside the phone body 102. The microprocessor 108 may be operatively coupled to and/or in signal communication with the input device 104, the display 106 and other phone components (not shown). As such, the microprocessor 108 may receive/send signals from/to the input device 104, the display 106 and/or other phone components, so as to control the input device 104, display 106 and/or other phone components to realize various functions of the mobile phone 100.

It is appreciated that the herein described methods and/or apparatus may likewise be practiced in other electrical devices, particularly in portable or handheld electronic devices, such as, for example, PDAs, electronic dictionaries, digital cameras, electronic game machines. Therefore, the mobile phone 100 as described and illustrated herein is for illustrative purposes only, and the methods and apparatus described herein is not intended to limit the scope of the present invention.

In the embodiment illustrated in FIG. 1, the input device 104 includes an integral touch screen 112. The integral touch screen 112 substantially occupies the whole front area of the phone body 102. The touch screen 112 further includes a key area 114 and a display area 116. By way of example, the key area 114 is positioned in the lower portion of the phone body 102, and the display area 116 is positioned in the upper portion of the phone body 102. In an exemplary embodiment, the touch screen 112 is a resistive touch screen. Alternatively, the touch screen 112 may be a capacitive touch screen. It is appreciated that the touch screen 112 may also be other types of touch screens, such as for example, surface acoustic wave touch screens or infrared sensing touch screen.

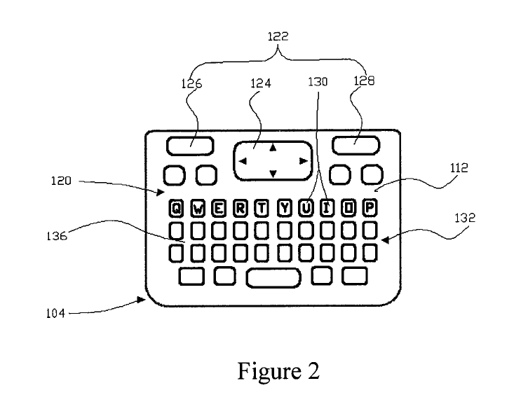

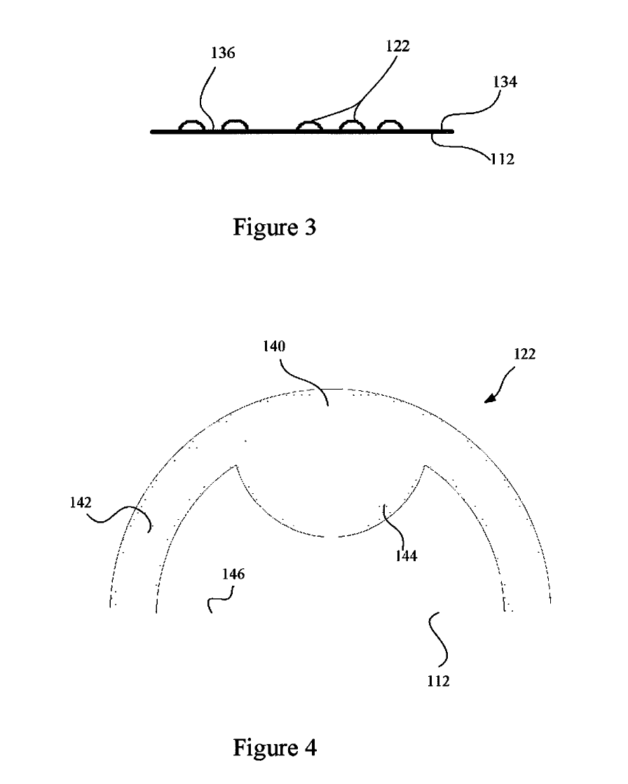

FIG. 2 is a partial top view of the input device 104 of the mobile phone 100 shown in FIG. 1, and FIG. 3 is a side view of the part of the input device 104 shown in FIG. 2. Specifically, FIG. 2 illustrates a plan view of the key area 114 of the touch screen 112.

In the illustrated embodiment, a key array 120 is positioned in the key area 114, and includes a plurality of keys 122. Specifically, the keys 122 may include a four-direction operation key 124, a left function key 126, a right function key 128 and a QWERTY keyboard 132. The QWERTY keyboard 132 includes a plurality of English alphabetical keys 130. In an exemplary embedment, each key 130 may be set as solely for the input of only one corresponding English alphabet, so as to improve the user's input speed in editing an e-mail or message. It is appreciated that the arrangement of the key array 120 is for illustrative purpose only, and the key array 120 may be arranged in other forms in alternative embodiments. In one embodiment, each key 130 corresponds to the input of a Chinese stroke. In another embodiment, the key array 120 is arranged in a traditional way, so that each key 130 corresponds to the input of three English letters.

As shown in FIG. 3, the keys 122 are positioned on an upper surface 134 of the touch screen 112. In an exemplary embodiment, the keys 122 are adhered to the touch screen 112. Specifically, the plurality of keys 122 may be originally connected with each other via a keyboard pad (not shown). The keyboard pad is attached to the upper surface 134 of the touch screen 112 via an adhesive. The keyboard pad may then be peeled off from the touch screen 112, and the plurality of keys 122 are left on the touch screen 112. As such, each key 122 is independently attached to the touch screen 112 and spaced with respect to one another. It is appreciated that the keys 122 may also be mounted on the touch screen 112 through other methods. For example, the keys 122 may be adhered to the touch screen 112 one by one, and the keys 122 may also be fixed onto the touch screen 112 by other methods such as snap-fitting.

In addition, a paint or coloured protection layer 136 may be applied on the key area 114 (see FIG. 2) of the touch screen 112. It may also be coated on the areas between the plurality of keys 122. As such, the key area 114 may be nontransparent, and has one or more colors to realize different visual and decorative effects. It is appreciated that the key area 114 of the touch screen 112 may also be transparent.

FIG. 4 is an enlarged cross-sectional view of an exemplary key 122 applicable to the present invention. In the illustrated embodiment, the key 122 is made of rubber, and is transparent or semi-transparent, so that light may pass through the key 122 (described in detail hereinafter). The key 122 is semi-circular in shape and defines an inner space therein. Specifically, the key 122 includes a press portion 140, an elastic support 142 and a protrusion 144 extending down from the inner side of the press portion 140. Each key 122 occupies an input area 146 on the surface 134 of the touch screen 112. When there is no external force applied on the key 122, the protrusion 144 is supported by the elastic support 142 and is positioned apart from the input area 146 of the touch screen 112. When the user presses the key 122 downward, the protrusion 144 is pressed against the touch screen 112. As such, the touch screen 112 detects the contact and generates an input signal. The elastic deformation of the key 122 provides tactile feedback to the user when operating the keys 122. In addition, some patterns such as alphabets, strokes and/or punctuations (not shown) may be formed inside the key 122 for indicating the corresponding input content of each key 122 by in-mode decoration.

It is appreciated that the keys 122 may be made of other elastic material rather than rubber, and may be partially transparent. In another embodiment, the keys 122 is mainly made of a rigid material, and may move up and down under the force of an elastic component It is also appreciated that the structure of the keys 122 are not limited to the illustrated semi-circular structure, and other key structures may also be used to form the keys of the present invention.

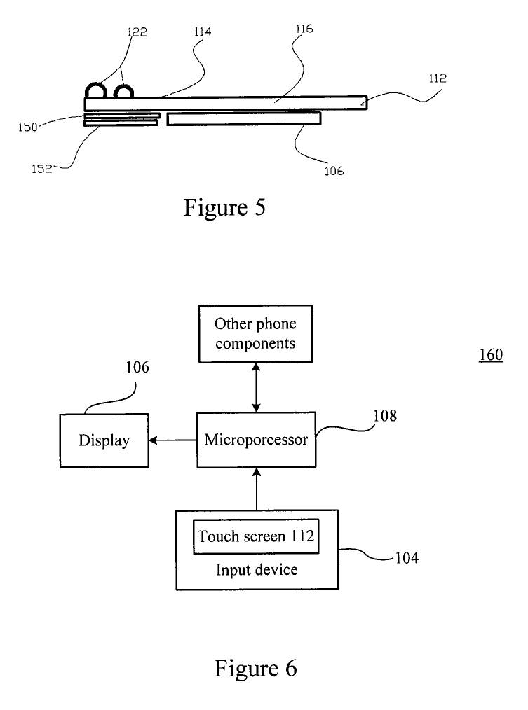

FIG. 5 is a cross-sectional view of the mobile phone 100 of FIG. 1. In the illustrated embodiment, the mobile phone 100 further includes a light guide plate 150 and a lighting source (not shown) attached to the underside of the touch screen 112. In an exemplary embodiment, the lighting source is a Light Emitting Diode (LED). The key area 114 of the touch screen 112 partially or completely covers the light guide plate 150, and light from the LED may pass through the light guide plate 150 to the key area 114. As discussed above, the keys 122 may be at least partially transparent or semi-transparent, so that light from the light source may pass through the key 122 to facilitate identifying the keys 122 in an environment with poor light. It is appreciated that other lighting components, such as electronic luminescence, may be used to replace the light guide plate 150 and LED for providing light for the key area 114.

In the present embodiment, a flexible circuit board 152 is mounted on the underside of the light guide plate 150. The flexible circuit board 152 electrically connects the touch screen 112 to the microprocessor 108 and provides a signal communication therebetween. When the touch screen 112 is touched by a touch pen, a finger or the key 122, an input signal is generated and transmitted to the microprocessor 108 through the flexible circuit board 152. It is appreciated that the flexible circuit board 152 may also be mounted at other places as long as it is able to realize the signal transmission between the touch screen 112 and the microprocessor 108.

In an exemplary embodiment, the touch screen 112 is a four-wire resistive touch screen, and the flexible circuit board 152 has four wires. As such, only four signal receiving ports on the microprocessor 108 are occupied for receiving input signals from the touch screen 112. It is appreciated that, in alternative embodiments, the number of the signal output ports of the touch screen 112 and the number of wires in the flexible circuit board 152 may increase or decrease.

In the illustrated embodiment, the display 106 is a Liquid Crystal Display (LCD), and is fixed onto the underside of the touch screen 112 via an adhesive. It is appreciated that the display 106 may also be a plasma display or other displays in alternative embodiments. As shown in FIG. 4, the display area 116 of the touch screen 112 may partially or completely cover the LCD 106. In an exemplary embodiment, the display area 116 of the touch screen 112 is transparent, so that the user may observe the content displayed on the display 106 through such display area 116.

In the embodiment illustrated in FIG. 5, the touch screen 112 is an integral panel, and the display area 116 and the key area 114 do not overlap with each other. In another embodiment, the touch screen 112 comprises two separate touch screens. One touch screen forms the display area 116, the other one forms the key area 114. The two touch screens may be coupled in signal communication with the microprocessor 108. In still another embodiment, the touch screen 112 includes only the key area 114, without the display area 116. In this embodiment, the touch screen 112 does not cover the display 106.

FIG. 6 is a block diagram of an exemplary system 160 applicable to the mobile phone 100 of FIG. 1. In the illustrated embodiment, the microprocessor 108 is in signal communication with the input device 104, specifically, in signal communication with the touch screen 112. As such, the microprocessor 108 may receive various operational instructions from the user. The microprocessor 108 is operatively coupled to the display 106 for controlling the content displayed on the display 106. It is appreciated that, the microprocessor 108 may also be operatively coupled to other phone components, such as for example, lighting sources, antennas, communication modules, data storages and/or speakers (not shown). As such, the microprocessor 108 may controls the phone components to perform various function of the mobile phone 100.

Referring to FIG. 5, as discussed above, the input signals generated by a touch pen or a finger touching the display area 116 or by pressing the key 112 in the key area 114 are transmitted to the microprocessor 108. The input signals may include a touch position, a press strength and/or other information. The microprocessor 108 analyzes the received input signals, and control the display 106 to display a corresponding content based on the received input signals. It is appreciated that the signals representing the touches in the display area 116 and the key area 114 may be independently, alternately or simultaneously generated and transmitted to the microprocessor 108.

When the user conducts input operations in the display area 116, the display 106 may display virtue buttons or patterns thereon. Based on such virtue buttons or patterns, the user may click, cross, select or otherwise operate corresponding positions of the display area 116 to input data or instructions. The user may also handwrite in the display area 116 to input letters and/or characters. It is appreciated that the methods for inputting based on such virtue buttons/patterns and for realizing the handwriting on the touch screen are within the purview of those skilled in the art, so further discussion thereof is omitted here.

As discussed above, the keys 122 are positioned in a certain arrangement in the key area 114 of the touch screen 112. When the user conducts input operations on the key area 114, each key 122 may press a specific input area 146 of the touch screen 112 to generate a corresponding input signal. As such, the key area 114 may have plurality of predetermined input areas 146 corresponding to different character/letter input signals. When the microprocessor 108 receives an input signal from the touch screen 112, the microprocessor 108 based on the pressed position in the key area 114 determines that a corresponding character/letter input is received. In a further embodiment, if the pressed position is within the key area 114 but out of any of the input areas 146, the microprocessor 108 may be programmed to ignore this input signal. The microprocessor 108 may, based on the received character/letter input signal, control the display 106 to display a corresponding content, generate a corresponding sound signal, and/or conduct other operations.

In an exemplary embodiment of the present invention, the touch screen 112 substantially covers the upper surface of the mobile phone 100, which facilitates realizing a reliable, waterproof, and dustproof for the mobile phone 100. In this embodiment, a plurality of keys 122 is provided on the touch screen 112, which provides good tactile feedback to the user, and facilitates increased input speed. In addition, comparing with existing mechanical keyboard, touch screen 112 occupies a less amount of input ports of the microprocessor, and the thickness of input device 104 may be significantly.

While the inventions have been described with reference to the certain illustrated embodiments, the words that have been used herein are words of description, rather than words of limitation. Changes may be made, without departing from the scope and spirit of the invention in its aspects. For example, the lighting source could be positioned in the different space in the apparatus. Although the inventions have been described herein with reference to particular structures, acts, the invention is not to be limited to the particulars described, but rather can be embodied in a wide variety of forms, some of which may be quite different from those of the disclosed embodiments, and extends to all equivalent structures, and acts, such as are within the scope of the appended claims.

What is claimed is:

1. An electronic device, comprising
a display configured to display a content;
an input unit comprising a touch screen and a key array on the touch screen, the touch screen at least partially covering the display, the key array comprising a plurality of keys, wherein the input unit is configured to generate an input signal when a key in the key array is pressed to touch the touch screen; and
a microprocessor operatively coupled to the display and the input unit, and configured to control the content displayed on the display in response to the input signal received from the input unit.

2. The electronic device according to claim 1, wherein the key array includes at least one key adhered to the touch screen.

3. The electronic device according to claim 1, wherein the key array includes at least one key made of rubber.

4. The electronic device according to claim 1, wherein the key array includes at least one key having a character pattern formed therein through in-mode decoration.

5. The electronic device according to claim 1, wherein at least one key of the key array comprises a protrusion extending downward the touch screen from an inner side thereof.

6. The electronic device according to claim 5, wherein the touch screen includes a resistive touch screen.

7. The electronic device according to claim 1, wherein the touch screen includes an integral touch screen having a display area and a key area.

8. The electronic device according to claim 7, wherein the display comprises a liquid crystal display and the display area of the touch screen at least partially covers the liquid crystal display.

9. The electronic device according to claim 7, wherein the key array is positioned on the key area of the touch screen, and the key area of the touch screen is nontransparent.

10. The electronic device according to claim 7, further comprising a light guide plate, wherein the key area of the touch screen at least partially covers the light guide plate.

11. An mobile phone, comprising
a display configured to display a content;
a touch screen at least partially covering the display, a key array on the touch screen, wherein the touch screen is configured to generate an input signal when at least one key in the key array is pressed to touch the touch screen; and
a microprocessor coupled in signal communication with the display and the touch screen, wherein the microprocessor is configured to control the content displayed on the display in response to the input signal received from the touch screen.

12. The mobile phone according to claim 11, wherein the key array includes at least one key adhered to the touch screen.

13. The mobile phone according to claim 11, wherein the key array includes at least one key made of rubber.

14. The mobile phone according to claim 11, wherein the key array includes at least one key comprising a character pattern formed therein through in-mode decoration.

15. The electronic device according to claim 11, wherein the key array includes at least one key comprising a protrusion extending downward from an inner side thereof.

16. The mobile phone according to claim 15, wherein the touch screen is a resistive touch screen.

17. The mobile phone according to claim 11, wherein: the touch screen is an integral touch screen, including a display area and a key area which do not overlap with each other; the display includes a liquid crystal display, and the display area of the touch screen at least partially covers the liquid crystal display.

18. The mobile phone according to claim 17, wherein the key array is positioned on the key area of the touch screen, and the key area of the touch screen is nontransparent.

19. The mobile phone according to claim 17, further comprising a light guide plate, the key area of the touch screen at least partially covering the light guide plate.

20. The mobile phone according to claim 17, wherein the key array further comprises a QWERTY keyboard.
